(19) United States
(12) Patent Application Publication
(10) Pub. No.: US 2026/0154996 A1
(43) Pub. Date: Jun. 4, 2026

(54) A TYRE RADIUS MONITOR

(71) Applicant: VOLVO TRUCK CORPORATION, Göteborg (SE)

(72) Inventors: Mats JONASSON, Partille (SE); Dhurai ISAAC PRABHAHAR, Göteborg (SE); Mats RYDSTRÖM, Billdal (SE)

(73) Assignee: VOLVO TRUCK CORPORATION, Göteborg (SE)

(21) Appl. No.: 19/123,213

(22) PCT Filed: Oct. 24, 2022
(86) PCT No.: PCT/EP2022/079496

§ 371 Date: Apr. 22, 2025

(51) Int. Cl. G07C 5/02; B60C 19/00; G01M 17/02; G01P 3/481

(52) U.S. Cl. CPC G07C 5/02; B60C 19/00; G01M 17/02; G01P 3/481; B60C 2019/004

(57) ABSTRACT

A computer-implemented method, for monitoring tyre radius data associated with one or more wheels of a heavy-duty vehicle includes selecting, by a processor device of a computer system, at least a subset of the one or more wheels of the heavy-duty vehicle, obtaining, by the processor device, respective wheel speeds for the wheels in the selected subset of wheels, determining, by the processor device, relative tyre radii quotients based on the tyre radius data and corresponding wheel speed quotients based on the wheel speeds, respectively, and declaring, by the processor device, an error if a difference between the relative tyre radii quotients and the corresponding wheel speed quotients fails to satisfy a difference acceptance criterion.

### TECHNICAL FIELD

This disclosure relates generally to control of heavy-duty vehicles such as trucks, busses and construction equipment. In particular aspects, the disclosure relates to a computer-implemented tyre radius monitor arranged to declare an error in case tyre radii data of the vehicle does not agree with wheel speed data. Although the disclosure may be described with respect to a particular vehicle, the disclosure is not restricted to any particular vehicle.

### BACKGROUND

Heavy-duty vehicles have traditionally been controlled using torque request signals generated based on the position of an accelerator or brake pedal and sent to motion support devices (MSDs) such as service brakes and propulsion devices over digital interfaces. However, advantages may be obtained by instead controlling the actuators using wheel slip or wheel speed requests sent from a central vehicle controller to the different actuators. This moves the actuator control closer to the wheel end, and therefore allows for a reduced latency and a faster more accurate control of the MSDs. Wheel-slip based vehicle motion management (VMM) and its associated advantages are discussed, e.g., in WO 2017/215751.

Wheel slip and wheel speed-based control of heavy-duty vehicles rely on accurate knowledge of the vehicle speed over ground as well as the rotation speed of the wheel in combination with the tyre radius of the wheel (normally its effective rolling radius) since these quantities together determine the wheel slip. It is important that these quantities are obtained by the VMM system in an accurate and reliable manner, otherwise the wheel-slip based control may not reach full potential.

Accurate knowledge of wheel slip is also important in anti-lock braking systems (ABS) as well as in traction control systems.

For these and other reasons, there is a need for improved methods of determining tyre radii of the wheels on a heavy-duty vehicle.

Accurate knowledge of vehicle speed is also important in order to enable successful tactical planning of vehicle maneuvers, including decision and control with respect to surrounding road users.

### SUMMARY

There is disclosed a computer-implemented method for monitoring tyre radius data associated with one or more wheels of a heavy-duty vehicle, where the tyre radius data comprises one or more tyre radius values associated with one or more wheels on the heavy-duty vehicle. The method comprises selecting, by a processor device of a computer system, at least a subset of the one or more wheels of the heavy-duty vehicle, obtaining, by the processor device, respective wheel speeds for the wheels in the selected subset of wheels, determining, by the processor device, relative tyre radii quotients based on the tyre radius data and corresponding wheel speed quotients based on the wheel speeds, respectively, and declaring, by the processor device, an error if a difference between the relative tyre radii quotients and the corresponding wheel speed quotients fails to satisfy a difference acceptance criterion.

Aspects of the disclosure may seek to provide a monitoring system which detects if tyre radius data used, e.g., for vehicle control, is accurate or if errors have been introduced in the tyre radius data that jeopardize safe handling of the vehicle for one or more maneuvers. A technical benefit of this may include a more safe vehicle operation.

According to some aspects, the method comprises selecting, by the processor device, a plurality of different subsets of wheels of the heavy-duty vehicle and identifying one or more failing wheels (wheels having inaccurate tyre radius data) based which subsets out of the plurality of selected subsets that generate a declared error by the processor device. This allows the system to not only detect when something is amiss in the overall tyre radius data, but also at least sometimes to determine which wheel or wheels that is/are associated with erroneous tyre radius data.

The tyre radius data optionally comprises tyre radii which have been estimated based on a travelled distance by the vehicle and on a corresponding number of wheel rotations, and/or based on output signals from one or more IMUs, and/or based on a measured vehicle speed and on a corresponding wheel speed of rotation. Hence, there are many different sources of tyre radius data which can be monitored by the herein described methods and systems. Different monitors can be instantiated for each type of tyre radius data, i.e., different configurations of difference acceptance criteria (such as thresholds or statistical tests) can be used for the different types of tyre radius data, with the associated advantage of allowing better overall performance of the relative tyre radius monitoring function. The tyre radius data may of course also comprise tyre radii which have been pre-configured by the processor device. Such pre-configured tyre radius data may also be considered as nominal tyre radius data which can be reverted to in case the tyre radius monitors declares an error for some other tyre radius data source.

According to some aspects, the method comprises obtaining the wheel speeds from Hall effect sensors or rotary encoders arranged in connection to the wheels. These sensor technologies provide reliable output and are commonly also available on vehicles.

The method may comprise determining the relative tyre radii quotients as

$$\frac{{R}_{i}}{{R}_{j}}$$

where Rᵢ and Rⱼ are tyre radii of the i-th and j-th wheel of the heavy-duty vehicle, and determining the corresponding wheel speed quotients as

$$\frac{{ω}_{x i}}{{ω}_{x j}}$$

where ωₓᵢ and ωₓⱼ are the wheel speeds of the i-th and j-th wheel. However, other types of quotients may also be considered. Hence, the methods discussed herein are not limited to any specific mathematical form of quotient.

The method may comprise declaring an error if

$$abs ( \frac{{ω}_{x i}}{{ω}_{x j}} - \frac{{R}_{i}}{{R}_{j}} ) \geq T h$$

where Th is a predetermined threshold value, Rᵢ and Rⱼ are measured or estimated tyre radii of the i-th and j-th wheel of the heavy-duty vehicle, and where ωₓᵢ and ωₓⱼ are wheel speeds of the i-th and j-th wheel of the heavy-duty vehicle. A straight-forward thresholding operation as the one above can be implemented with limited computational complexity which is an advantage. As noted above, different threshold values can be used or different types of tyre radius data sources, as some sources are associated with larger deviations from the corresponding wheel speeds than other sources.

According to some aspects the method comprises triggering generation of a notification and/or warning message to a VMM system of the heavy-duty vehicle in response to declaring an error by the processor device. This means that the uncertainty in tyre radius data that has been detected is communicated to functions which may benefit from the information, allowing implementation of various countermeasures, such as reducing a vehicle speed, and/or executing a situation avoidance maneuver (SAM) in response to declaring an error by the processor device. The SAM may, e.g., comprise maneuvering the vehicle to the side of the road and stopping the vehicle, or updating an operational design domain (ODD) of the vehicle to disallow more challenging operations that require accurate tyre radius information.

According to some aspects the vehicle is associated with an ODD that limits the allowable vehicle state space, such as the maximum velocity allowed by the vehicle, or the maximum curvature, or some combination thereof. The VMM of the vehicle may be arranged to determine the ODD to use for controlling the vehicle based on if the tyre radius monitor declares an error or not. In case no error is declared then the vehicle may be permitted to undertake more aggressive maneuvers (requiring more accurate tyre radius data) compared to when an error is declared.

The method may also comprise obtaining data indicative of a current motion state of the heavy-duty vehicle, and declaring an error only if the current motion state satisfies a motion state acceptance criterion. This motion state acceptance criterion may be indicative of an operating condition where there is a clear relationship between wheel speeds and tyre radii, i.e., a case where wheel slip is negligible or the like. By declaring an error only if the current motion state satisfies the motion state acceptance criterion a more dependable monitor is obtained with a reduced rate of false alarms, which is an advantage. The motion state acceptance criterion may comprise any of; a vehicle curvature criterion, a vehicle acceleration criterion, and a vehicle wheel force criterion.

The above aspects, accompanying claims, and/or examples disclosed herein above and later below may be suitably combined with each other as would be apparent to anyone of ordinary skill in the art.

Additional features and advantages are disclosed in the following description, claims, and drawings, and in part will be readily apparent therefrom to those skilled in the art or recognized by practicing the disclosure as described herein. There are also disclosed herein control units, computer systems, computer readable media, and computer program products associated with the above discussed technical benefits.

### BRIEF DESCRIPTION OF THE DRAWINGS

With reference to the appended drawings, below follows a more detailed description of aspects of the disclosure cited as examples.

FIG. 1 illustrates an example heavy-duty vehicle,

FIG. 2 is a graph showing example tyre forces as function of wheel slip,

FIG. 3 schematically illustrates aspects of an example vehicle control system,

FIG. 4 schematically illustrates aspects of an example vehicle control system,

FIG. 5 illustrates an example heavy-duty vehicle,

FIG. 6 is a schematic diagram of an exemplary computer system,

FIG. 7 is a flow chart illustrating methods, and

FIG. 8 shows an example computer program product.

### DETAILED DESCRIPTION

The present disclosure will now be described more fully hereinafter with reference to the accompanying drawings, in which exemplary embodiments are shown. The disclosure may, however, be embodied in many different forms and should not be construed as limited to the embodiments set forth herein; rather, these embodiments are provided for thoroughness and completeness. Like reference character refer to like elements throughout the description. Aspects set forth below represent the necessary information to enable those skilled in the art to practice the disclosure.

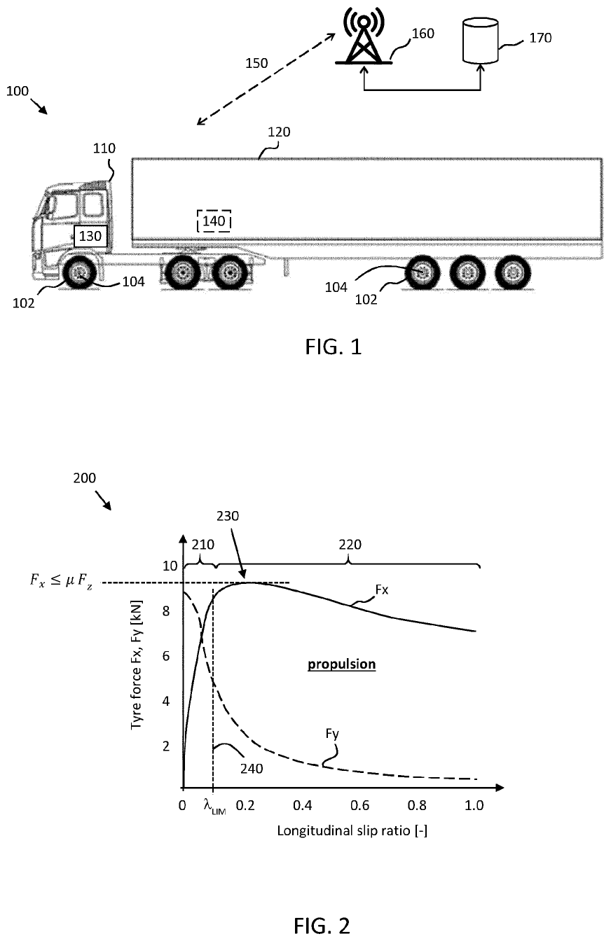

FIG. 1 illustrates an example heavy-duty vehicle 100, here in the form of a truck comprising a tractor 110 and a trailer 120. The vehicle 100 comprises a plurality of wheels 102, wherein at least a subset of the wheels 102 comprises a respective motion support device (MSD) 104, such as a service brake, an electric machine, a power steering arrangement, active suspension, and/or a power transmission that connects the wheel to a motor such as a combustion engine or central electric machine. It should be readily understood that one or more pairs of wheels may be arranged without an MSD. Also, an MSD may be arranged connected to more than one wheel, e.g., via a differential drive arrangement.

It is appreciated that the herein disclosed methods, computer systems and computer-implemented control units can be applied with advantage also in other types of heavy-duty vehicles, such as trucks with drawbar connections, construction equipment, buses, and the like. The vehicle 100 may also comprise more than two vehicle units, i.e., a dolly vehicle unit may be used to tow more than one trailer.

The vehicle 100 comprises a computer-implemented control system arranged to control vehicle motion, among other things. This control system may comprise one or more control units 130, 140 distributed over the vehicle or centralized at one place. Each vehicle control unit 130, 140 may comprise one or more processor devices. A processor device may also be distributed over several spatially separated units or centralized in one place. The control system, or parts thereof, may be arranged to communicate via wireless link 150 to a wireless access point 160, such as a radio base station 160 of a cellular access network or the like. Thus, the vehicle control system may communicate with one or more remote servers 170, data repositories, and remote processing resources, in order to exchange data and perform various computation tasks. The vehicle control system 130, 140 may be referred to as a system for vehicle motion management (VMM).

Longitudinal wheel slip λₓ may, in accordance with SAE J370 (SAE Vehicle Dynamics Standards Committee Jan. 24, 2008) be defined as

$${λ}_{x} = \frac{R {ω}_{x} - {v}_{x}}{max ( \vert R {ω}_{x} \vert , \vert {v}_{x} \vert )}$$

where R is an effective wheel radius (sometimes referred to as an effective wheel rolling radius) in meters, ωₓ is the angular velocity of the wheel, and vₓ is the longitudinal speed of the wheel (in the coordinate system of the wheel). Thus, λₓ is bounded between −1 and 1 and quantifies how much the wheel is slipping with respect to the road surface. Wheel slip is, in essence, a speed difference measured between the wheel and the vehicle.

Slip angle α, also known as sideslip angle, is the angle between the direction in which a wheel is pointing and the direction in which it is actually traveling (i.e., the angle between the longitudinal velocity component vₓ and the vector sum of wheel forward velocity vₓ and lateral velocity v_{y}. This slip angle results in a force, the cornering force, which is in the plane of the contact patch and perpendicular to the intersection of the contact patch and the midplane of the wheel. The cornering force increases approximately linearly for the first few degrees of slip angle, then increases non-linearly to a maximum before beginning to decrease.

The slip angle, α is often defined as

$$α = arctan ( \frac{{v}_{y}}{\vert {v}_{x} \vert} )$$

where v_{y} is the lateral speed of the wheel in the coordinate system of the wheel.

Herein, longitudinal speed over ground may be determined relative to the vehicle, in which case the speed direction refers to the forward direction of the vehicle or relative to a wheel, in which case the speed direction refers to the forward direction, or rolling direction, of the wheel. The same is true for lateral speed over ground, which can be either a lateral speed of the vehicle or a lateral speed over ground of a wheel relative to its rolling direction. The meaning will be clear from context, and it is appreciated that a straight-forward conversion can be applied in order to translate speed over ground between the coordinate system of the vehicle and the coordinate system of the wheel, and vice versa. Vehicle and wheel coordinate systems are discussed, e.g., by Thomas Gillespie in “Fundamentals of Vehicle Dynamics” Warrendale, PA: Society of Automotive Engineers, 1992.

In order for a wheel (or tyre) to produce a wheel force which affects the motion state of the heavy-duty vehicle, such as an acceleration, slip must occur. For smaller slip values the relationship between slip and generated force is approximately linear, where the proportionality constant is often denoted as the slip stiffness Cₓ of the tyre. A tyre is subject to a longitudinal force Fₓ, a lateral force F_{y}, and a normal force F_{z}. The normal force F_{z} is key to determining some important vehicle properties. For instance, the normal force to a large extent determines the achievable longitudinal tyre force Fₓ by the wheel since, normally, Fₓ≤μF_{z}, where μ is a friction coefficient associated with a road friction condition. The maximum available lateral force for a given wheel slip can be described by the so-called Magic Formula as described in “Tyre and vehicle dynamics”, Elsevier Ltd. 2012, ISBN 978-0-08-097016-5, by Hans Pacejka, where wheel slip and tyre force is also discussed in detail.

FIG. 2 is a graph showing an example 200 of achievable tyre forces as function of longitudinal wheel slip. Fx is the longitudinal tyre force while Fy is the maximum obtainable lateral wheel force for a given wheel slip. This type of relationship between wheel slip and generated tyre force is often referred to as an inverse tyre model, and it is generally known. The examples in FIG. 2 are for positive wheel forces, i.e., propulsion. Similar relationships exist between wheel slip and negative wheel force, i.e., braking.

An inverse tyre model can be used to translate between a desired longitudinal tyre force Fₓ and longitudinal wheel slip λₓ. The interface between VMM and MSDs capable of delivering torque to the vehicle's wheels has as mentioned above traditionally been focused on torque-based requests to each MSD from the VMM without any consideration towards wheel slip. However, this approach has some performance limitations. In case a safety critical or excessive slip situation arises, then a relevant safety function (traction control, anti-lock brakes, etc.) operated on a separate control unit normally steps in and requests a torque override in order to bring the slip back into control. The problem with this approach is that since the primary control of the actuator and the slip control of the actuator are allocated to different electronic control units (ECUs), the latencies involved in the communication between them significantly limits the slip control performance. Moreover, the related actuator and slip assumptions made in the two ECUs that are used to achieve the actual slip control can be inconsistent and this in turn can lead to sub-optimal performance. Significant benefits can be achieved by instead using a wheel speed or wheel slip-based request on the interface between VMM and the MSD controller or controllers, thereby shifting the difficult actuator speed control loop to the MSD controllers, which generally operate with a much shorter sample time compared to that of the VMM system. Such an architecture can provide much better disturbance rejection compared to a torque-based control interface and thus improves the predictability of the forces generated at the tyre road contact patch.

Referring again to FIG. 2, the example longitudinal tyre force Fx shows an almost linearly increasing part 210 for small wheel slips, followed by a part 220 with more non-linear behavior for larger wheel slips. It is desirable to maintain vehicle operation in the linear region 210, where the obtainable longitudinal force in response to an applied brake command is easier to predict, and where enough lateral tyre force can be generated if needed. To ensure operation in this region, a wheel slip limit λₗᵢₘ 240 on the order of, e.g., 0.1 or so, can be imposed on a given wheel. Thus, having accurate knowledge of current wheel slip, operation in the linear region can be ensured, which greatly simplifies vehicle motion control for both safety, efficiency, and driver comfort.

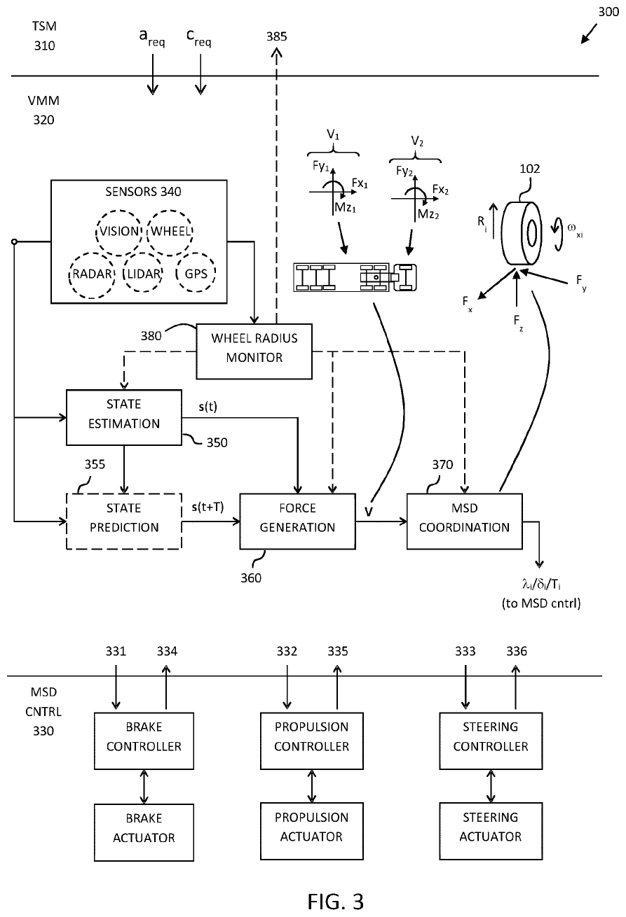

FIG. 3 schematically illustrates functionality 300 for controlling the vehicle 100 by some example MSDs here comprising brake actuators, propulsion actuators, and power steering, with respective controllers collectively referred to in FIG. 3 as MSD control 330. A traffic situation management (TSM) function 310 plans driving operation with a time horizon of 10 seconds or so. This time frame corresponds to, e.g., the time it takes for the vehicle 100 to negotiate a curve or the like. The vehicle maneuvers, planned and executed by the TSM function 310, can be associated with acceleration profiles a_{req} and curvature profiles c_{req} which describe a desired target vehicle velocity in the vehicle forward direction and turning to be maintained for a given maneuver. The TSM function continuously requests the desired acceleration profiles a_{req} and steering angles (or curvature profiles c_{req}) from the VMM system 320 which performs force allocation to meet the requests from the TSM function in a safe and robust manner. The VMM system 320 operates on a timescale of below one second or so and will be discussed in more detail below.

Each wheel 102 on the vehicle has a longitudinal velocity component vₓ and a lateral velocity component v_{y} (in the coordinate system of the wheel or in the coordinate system of the vehicle, depending on implementation). There is a longitudinal wheel force Fₓ and a lateral wheel force F_{y}, and also a normal force F_{z} acting on the wheel (not shown in FIG. 3). Unless explicitly stated otherwise, the wheel forces are defined in the coordinate system of the wheel, i.e., the longitudinal force is directed in the rolling plane of the wheel, while the lateral wheel force is directed normal to the rolling plane of the wheel. The wheel has a rotational velocity ωₓ, and a tyre radius R.

The type of inverse tyre models exemplified by the graph 200 in FIG. 2 can be used by the VMM function 320 to generate a desired tyre force at some wheel. Instead of requesting a torque corresponding to the desired tyre force, the VMM can translate the desired tyre force into an equivalent wheel slip (or, equivalently, a wheel speed relative to a speed over ground) and request this slip instead. The main advantage being that the MSD control device 330 will be able to deliver the requested torque with much higher bandwidth by maintaining operation at the desired wheel slip, using the vehicle speed vₓ from the vehicle speed sensor and the wheel rotational velocity ωₓ, obtained from the wheel speed sensor.

The control unit or units can be arranged to store one or more pre-determined inverse tyre models in memory, e.g., as look-up tables or parameterized functions. An inverse tyre model can also be arranged to be stored in the memory as a function of the current operating condition of the wheel.

With continued reference to FIG. 3, the TSM function 310 generates vehicle motion requests which may comprise a desired curvature c_{req} to be followed by the vehicle, and desired vehicle unit accelerations a_{req}. Given the discussion above in connection to FIG. 2, it is understood that the motion requests can be used as base for determining or predicting a required amount of longitudinal and lateral forces which needs to be generated in order to successfully complete a maneuver.

The VMM system 320 operates with a time horizon of about 1 second or so, and continuously transforms the acceleration profiles a_{req} and curvature profiles c_{req} from the TSM function 310 into control commands 331, 332, 333 for controlling vehicle motion functions, actuated by the different MSDs of the vehicle 100 which report back capabilities 334, 335, 336 to the VMM function 320, which in turn are used as constraints in the vehicle control. The VMM system 320 performs vehicle state or motion estimation 350, i.e., the VMM system 320 continuously determines a vehicle state s as function of time t comprising positions, speeds, accelerations, and articulation angles of the different units in the vehicle combination by monitoring operations using various sensors 340 arranged on the vehicle 100, often but not always in connection to the MSDs. An important input to the state estimation 350 may of course be the signals from the vehicle speed sensor and the wheel speed sensors on the heavy-duty vehicle 100.

The result of the state estimation 350, i.e., the estimated vehicle state s, is input to a force generation module 360 which determines the required global forces V=[V₁, V₂] for the different vehicle units to cause the vehicle 100 to move according to the requested acceleration and curvature profiles a_{req}, c_{req}, and to behave according to the desired vehicle behavior. The required global force vector V is input to an MSD coordination function 370 which allocates wheel forces and coordinates other MSDs such as steering and suspension. The MSD coordination function outputs an MSD control allocation for the i:th wheel, which may comprise any of a torque Tᵢ, a longitudinal wheel slip λᵢ, a wheel rotational speed ωᵢ, and/or a wheel steering angle δᵢ. The coordinated MSDs then together provide the desired lateral Fy and longitudinal Fx forces on the vehicle units, as well as the required moments Mz, to obtain the desired motion by the vehicle combination 100.

Thus, according to some aspects of the present disclosure, the VMM system 320 manages both force generation and MSD coordination, i.e., it determines what forces that are required at the vehicle units in order to fulfil the requests from the TSM function 310, for instance to accelerate the vehicle according to a requested acceleration profile requested by TSM and/or to generate a certain curvature motion by the vehicle also requested by TSM. The forces may comprise e.g., yaw moments Mz, longitudinal forces Fx and lateral forces Fy, as well as different types of torques to be applied at different wheels. The forces are determined such as to generate the vehicle behavior which is expected by the TSM function in response to the control inputs generated by the TSM function 310.

A problem encountered when using wheel slip to actively control one or more wheels on a heavy-duty vehicle, such as the vehicle 100, and also when executing more low complex control such as imposing the above-mentioned wheel slip limit λₗᵢₘ locally at wheel end, is that the tyre radii may not be accurately known for all wheels of the heavy-duty vehicle 100. The tyre radius may vary significantly with nominal tyre inflation pressure, tyre temperature, tyre wear, and general tyre construction.

It is possible to measure or estimate the tyre radius of a wheel, for instance as an effective tyre rolling radius. This can be done, e.g., by recording a travelled distance by a vehicle in a time period (using a GPS system or a map) and comparing this distance to the number of rotations of a wheel during the same time period. Suppose that a travelled distance D (in meters) is measured using a map or some form of GPS-based sensor system, and that the number of wheel rotations N is recorded for some wheel on the vehicle as it travels the distance D. These two quantities can be used to determine effective rolling radius for the i-th wheel, by the relationship

$${R}_{i} \approx \frac{D}{2 π N}$$

The relation between tyre radius Rᵢ and travelled distance D above assumes no wheel slip. If wheel slip is present N will change. This effect can, however, at least partly be reduced if slip is estimated and taken into account by the travelled distance based tyre radius estimator. The longer the distance travelled, the more accurate the estimate of effective rolling radius will be since measurement noise and other transient disturbances will be averaged out. However, travelling a longer distance also takes a longer time, which means that it will take time to generate a reliable estimate of effective rolling radius Rᵢ. Thus, an accurate rolling radius measurement can be at least temporarily offset from its true value if the vehicle load changes, or if the tyre temperature changes faster than the tyre radius estimation algorithm can adapt. Thus, it is appreciated that the the tyre radius data may comprises tyre radii which have been estimated based on a travelled distance D by the vehicle 100 and on a corresponding number N of wheel rotations

The effective rolling radius Rᵢ of the i-th wheel 102 can also be obtained from a comparison of wheel acceleration parallel to the road surface and the angular acceleration of the wheel 102. As long as there is no large amount of wheel slip,

$${\dot{v}}_{xi} \approx {R}_{i} {\dot{ω}}_{xi}$$

where \dot{v}ₓᵢ is the longitudinal acceleration of the wheel axle of the i-th wheel parallel to the road surface (obtained, e.g., from an IMU) and \dot{ω}ₓᵢ is the angular acceleration of the i-th wheel (obtained from a wheel speed sensor or the like). However, measurement noise and other disturbances will have to be suppressed by averaging, which again introduces significant latency in the process for estimating effective rolling radius. In addition, an unknown bias in the longitudinal acceleration \dot{v}ₓᵢ could result in an erroneous estimate of tyre radius Rᵢ. It is thus appreciated that the tyre radius data may comprise tyre radii which have been estimated based on output signals from one or more IMUs 510.

The effective rolling radius Rᵢ of the i-th wheel 102 can also be obtained from a comparison of vehicle speed vₓᵢ with a corresponding wheel angular velocity ωₓᵢ, as the two are related according to

$${v}_{xi} \approx {R}_{i} {ω}_{xi}$$

Thus, it is appreciated that the tyre radius data may comprise tyre radii which have been estimated based on a measured vehicle speed vₓ and on a corresponding wheel speed of rotation ωₓ.

Measuring and/or estimating tyre radii can be done in a number of different ways known in the art, including manual measurement of the tyre radius when the vehicle is stationary. Methods for measuring and/or estimating tyre radius will therefore not be discussed in more detail herein.

The methods for measuring and/or estimating tyre radius may not always be accurate. For instance, some of the measurement methods are associated with relatively long delays before the tyre radius data has converged to a value close to the true value. In this case it will take time for the tyre radius data to converge to a new true value after an abrupt change in tyre radius due to, e.g., change in vehicle load, change in tyre temperature, or the like. Other methods may also arrive at an erroneous estimate, for instance if the travelled distance by a GPS system is recorded in error, or the output from the IMU is erroneous for some reason. It is therefore desired to implement a monitor which keeps track of the tyre radius data available to the vehicle control system and declares an error in case too large errors are noted in the tyre radius data. A wheel radius monitor 380 is illustrated in FIG. 3, which continuously or periodically monitors the tyre radius data used by the VMM function and elsewhere in the heavy-duty vehicle, to make sure that the tyre radius data is consistent and does not appear to be in error. The output from the tyre radius monitor 380 can be used directly in the state estimation module 350, in the force generation module 360, and/or by the MSD coordination module 370. The output can also be used generally to trigger a notification 385 to a TSM function, which may then result in a reduction in vehicle speed or in the execution of a situation avoidance maneuver (SAM), such as a full stop of the vehicle at a location deemed sufficiently safe.

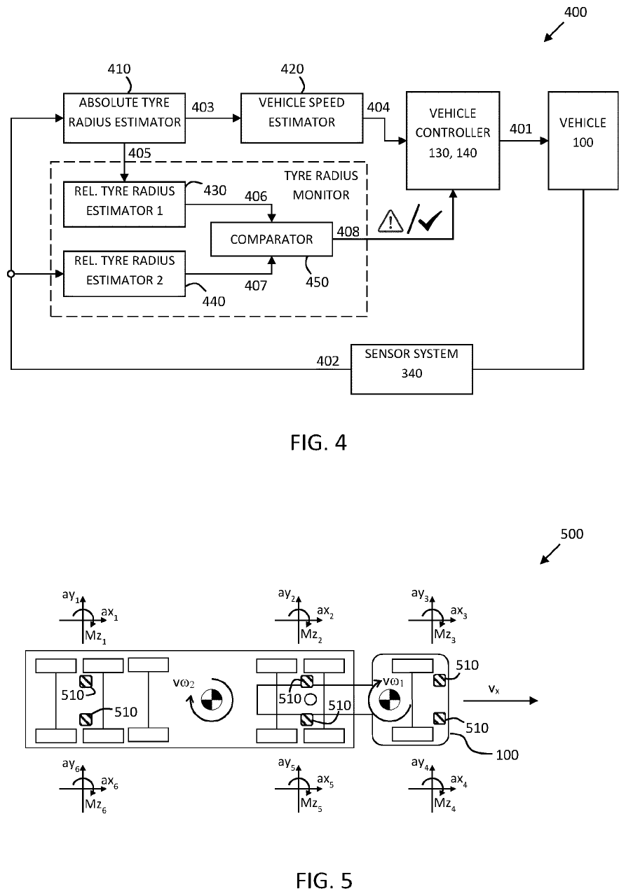

FIG. 4 schematically illustrates a computer-implemented vehicle control system 400, which can be realized on, e.g., one or more processor devices on the vehicle 100. A vehicle controller 130, 140 controls vehicle motion, e.g., by requesting 401 torques or wheel slips from MSDs of the vehicle 100.

A sensor system 340 is arranged to sense vehicle motion. The output 402 from the sensor system 340 may comprise, e.g., wheel angular speeds, IMU data, and also GPS position of the vehicle over time. Outputs related to vehicle speed over ground obtained from radar-based sensors, lidar-based sensors, and vision-based sensors can also be used.

The output 402 from the sensor system 340 is used as input to an absolute tyre radius estimator function 410 which determines current tyre radii of the wheels on the vehicle 100 in real time or at least in near-real time. The output 403 from the absolute tyre radius estimator function 410 can, e.g., be used by a vehicle speed estimator function 420, which then feeds vehicle speed information 404 to the vehicle controller 130, 140.

The tyre radius data from the absolute tyre radius estimator function 410 is also output 405 to a first relative tyre radius estimator function 430, which determines quotients of at least a subset of the tyre radii in the tyre radius data. In other words, if the tyre radius data comprises a set of N tyre radii
{R₁, R₂, . . . , R_{N}}

then the first relative tyre radius estimator function 430 may determine quotients

$$\{ \frac{{R}_{2}}{{R}_{1}} , \frac{{R}_{3}}{{R}_{1}} , … , \frac{{R}_{N}}{{R}_{1}} \}$$

where the first tyre radius R₁ has been chosen as reference. Other quotients may of course also be used. Generally, the more quotients that are determined the better.

The output 402 from the sensor system 340, specifically the wheel angular speeds ωₓᵢ of at least some wheels on the vehicle 100, is also used as input to a second relative tyre radius estimator function 440. This second relative tyre radius estimator function 440 also determines quotients based on the wheel angular speeds ωₓᵢ, i.e., a set

$$\{ \frac{{ω}_{x 2}}{{ω}_{x 1}} , \frac{{ω}_{x 3}}{{ω}_{x 1}} , … , \frac{{ω}_{xN}}{{ω}_{x 1}} \}$$

where again the first wheel has been selected as reference. Any given tyre radius quotient

$$\frac{{R}_{i}}{{R}_{j}}$$

has a corresponding wheel angular speed quotient

$$\frac{{ω}_{xi}}{{ω}_{xj}} .$$

I.e., corresponding tyre radius and wheel speed quotients have the same wheel in the nominator and the same wheel in the denominator. In case the tyre radii and the wheel speed signals are both accurate, then the corresponding set elements should be equal or at least similar, i.e.,

$$\frac{{ω}_{x 2}}{{ω}_{x 1}} \approx \frac{{R}_{2}}{{R}_{1}} , \frac{{ω}_{x 3}}{{ω}_{x 1}} \approx \frac{{R}_{3}}{{R}_{1}} , … , \frac{{ω}_{xN}}{{ω}_{x 1}} \approx \frac{{R}_{N}}{{R}_{1}}$$

while if one or more radii or wheel speeds is in error, differences between the quotients will likely be observed.

The tyre radius quotients and the wheel speed quotients are output 406, 407 to a comparator function 450 which compares the two sets in order to verify if the two sets comply with each other, i.e., if the difference between the relative tyre radii quotients

$$\{ \frac{{R}_{2}}{{R}_{1}} , \frac{{R}_{2}}{{R}_{1}} , … , \frac{{R}_{N}}{{R}_{1}} \}$$

and the corresponding wheel speed quotients

$$\{ \frac{{ω}_{x 2}}{{ω}_{x 1}} , \frac{{ω}_{x 3}}{{ω}_{x 1}} , … , \frac{{ω}_{xN}}{{ω}_{x 1}} \}$$

fail to satisfy a difference acceptance criterion, such as the differences all being below some threshold value. In case of a declared error by the comparator 450, the VMM function 320 or the TSM function 310 may take appropriate action, such as reducing vehicle speed, generating a warning to the driver, or even performing some type of situation avoidance maneuver such as an emergency stop.

FIG. 7 shows a flow chart that illustrates a method which summarizes at least some of the discussion above. FIG. 7 illustrates a computer-implemented method for monitoring tyre radius data associated with one or more wheels 102 of a heavy-duty vehicle 100. The wheels may be arranged on a tractor 110 and/or on a trailer 120, or on some other vehicle unit such as a dolly or the like. The method comprises selecting S1, by a processor device of a computer system, at least a subset of the one or more wheels 102 of the heavy-duty vehicle 100 and obtaining S2, by the processor device, respective wheel speeds for the wheels in the selected subset of wheels. The subset of wheels may comprise all wheels on the vehicle, or just a subset of wheels, such as a subset of wheels having torque generating capability. Two or more subsets of wheels can also be selected, as will be discussed in more detail below. The wheel speeds may, e.g., be obtained S21 from Hall effect sensors or rotary encoders arranged in connection to the wheels.

The method comprises determining S3, by the processor device, relative tyre radii quotients (Rᵢ/Rⱼ) based on the tyre radius data and corresponding wheel speed quotients (ωₓᵢ/ωₓⱼ) based on the wheel speeds, respectively, and declaring S4, by the processor device, an error if a difference between the relative tyre radii quotients and the corresponding wheel speed quotients fails to satisfy a difference acceptance criterion. This monitoring principle was discussed above. As long as the tyre radii are reasonably accurate and the wheel speeds are close to the true wheel speeds, then the tyre radius quotients will be similar or even equal to the wheel speed quotients. However, if too large errors are introduced in the tyre radii (or in the wheel speeds), then an error will be declared.

According to some aspects of the method, it also comprises selecting S11, by the processor device, a plurality of different subsets of wheels 102 of the heavy-duty vehicle 100 and identifying S5 one or more failing wheels based which subsets out of the plurality of selected subsets that generate a declared error by the processor device. Suppose for instance that all wheels except the first wheel is selected, and that this selection results in no declared error, while a selection of wheels comprising the first wheel does, then it can be suspected that the first wheel either has an erroneous wheel speed signal associated with it, or an incorrectly determined tyre radius. The wheel speed sensor signals are normally very dependable, and so an erroneous tyre radius is often more likely. This way one or more tyres associated with incorrect tyre radius can be identified by the method, in addition to declaring a general error related to the overall tyre radius data.

The tyre radius data may, e.g., comprise tyre radii which have been estimated based on a travelled distance by the vehicle 100 and on a corresponding number of wheel rotations, as mentioned above, or tyre radii which have been estimated based on output signals from one or more inertial measurement units, IMU, 510, or tyre radii which have been estimated based on a measured vehicle speed vₓ and on a corresponding wheel speed of rotation ωₓ. The tyre radius data may also comprise tyre radii which has been pre-configured by the processor device. It is noted that the tyre radius data file used by the vehicle control system or system can comprise more than one tyre radius estimate or measurement per tyre. The vehicle controllers may implement two or more methods of tyre radius determination, and all these data points can be verified by the herein disclosed techniques for tyre radius monitoring. Thus, it is appreciated that the declaration of error can also be associated with a given tyre radius estimation method. In other words, the processor device may declare an error for the tyre radius data obtained from travelled distance and wheel rotations, but not from the tyre radius data obtained based on the IMU signal, or the other way around. When an error is declared for some advanced tyre radius estimation algorithm that the vehicle implements, the vehicle controller may choose to revert to a nominal or preconfigured tyre radius value for one or more of the tyres on the vehicle, as long as this part of the tyre radius data is also not declared to be in error.

The method optionally comprises determining S31 the relative tyre radii Rᵢ quotients as

$$\frac{{R}_{i}}{{R}_{j}}$$

where Rᵢ and Rⱼ are tyre radii of the i-th and j-th wheel of the heavy-duty vehicle 100, and determining the corresponding wheel speed quotients as

$$\frac{{ω}_{xi}}{{ω}_{xj}}$$

where ωₓᵢ and ωₓⱼ are the wheel speeds of the i-th and j-th wheel. Other forms of compliance checks can of course also be implemented, such as computing an average conversion factor α between wheel angular speeds and tyre radii as function of the vehicle speed over ground, i.e., such that ωₓᵢ=αRᵢ if the tyre radius data is correct, and ωₓᵢ≠αRᵢ otherwise.

The method may comprise comprising declaring S41 an error if

$$abs ( \frac{{ω}_{xi}}{{ω}_{xj}} - \frac{{R}_{i}}{{R}_{j}} ) \geq Th$$

where Th is a predetermined threshold value, Rᵢ and Rⱼ are measured or estimated tyre radii of the i-th and j-th wheel of the heavy-duty vehicle 100, and where ωₓᵢ and ωₓⱼ are wheel speeds of the i-th and j-th wheel of the heavy-duty vehicle 100. Other tests can of course also be applied by the monitor to the determined quotients. A statistical test can for instance be used to determine if the difference between the relative tyre radii quotients and the corresponding wheel speed quotients fails to satisfy the difference acceptance criterion. A statistical hypothesis test can be used. This is a method of statistical inference used to decide whether the data at hand (the quotients) sufficiently support a particular hypothesis or not (satisfying the difference acceptance criterion). Statistical test methods are generally known and will therefore not be discussed in more detail herein.

The method may comprise triggering S42 generation of a notification and/or warning message to a VMM function 320 and/or to a TSM function 310 of the heavy-duty vehicle 100 in response to declaring an error by the processor device, and reducing S43 a vehicle speed, and/or executing S44 a SAM in response to declaring an error by the processor device.

It is appreciated that the tyre radius monitoring techniques discussed herein relay on a relationship between relative wheel speeds and relative tyre radii. This relationship may not hold in some cases, particularly if the wheels are slipping excessively or the vehicle is turning at high rate. In order to make sure that the tyre radius monitoring system is only active when it is feasible to perform the comparison of relative tyre radii and corresponding relative wheel speeds, the method may comprise obtaining S45 data indicative of a current motion state of the heavy-duty vehicle 100 and declaring an error only if the current motion state satisfies a motion state acceptance criterion. The motion state acceptance criterion may for instance comprise any of a vehicle curvature criterion, a vehicle acceleration criterion, a vehicle wheel force criterion, or some other signal that correlates with the desired vehicle behavior where there is a clear connection between wheel speeds and tyre radius. The vehicle curvature criterion is preferably configured to ensure that the vehicle is not turning too much during execution of the monitoring operations. This can, for instance, involve placing bounds on allowable yaw rate by the vehicle, steering, or lateral slip. The vehicle acceleration criterion essentially aims to make sure that wheels are not slipping too much. This may involve placing bounds on allowable longitudinal acceleration, applied wheel torque, applied wheel force, or wheel angular acceleration.

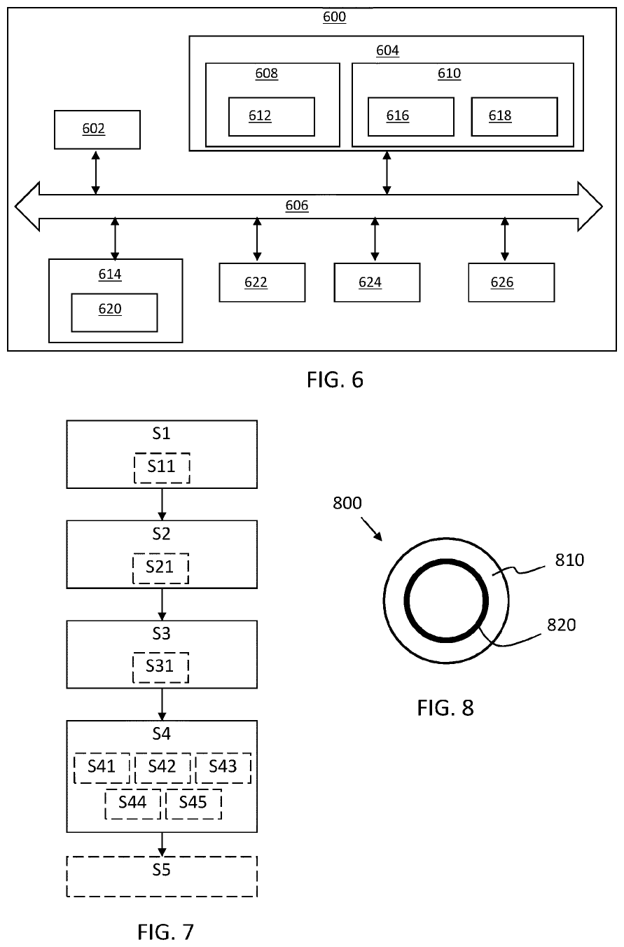

FIG. 6 is a schematic diagram of a computer system 600 for implementing examples disclosed herein. The computer system 600 is adapted to execute instructions from a computer-readable medium to perform these and/or any of the functions or processing described herein. The computer system 600 may be connected (e.g., networked) to other machines in a LAN, an intranet, an extranet, or the Internet. While only a single device is illustrated, the computer system 600 may include any collection of devices that individually or jointly execute a set (or multiple sets) of instructions to perform any one or more of the methodologies discussed herein.

Accordingly, any reference in the disclosure and/or claims to a computer system, computing system, computer device, computing device, control system, control unit, electronic control unit (ECU), processor device, etc., includes reference to one or more such devices to individually or jointly execute a set (or multiple sets) of instructions to perform any one or more of the methodologies discussed herein. For example, control system may include a single control unit, or a plurality of control units connected or otherwise communicatively coupled to each other, such that any performed function may be distributed between the control units as desired. Further, such devices may communicate with each other or other devices by various system architectures, such as directly or via a Controller Area Network (CAN) bus, etc.

The computer system 600 may comprise at least one computing device or electronic device capable of including firmware, hardware, and/or executing software instructions to implement the functionality described herein. The computer system 600 may include a processor device 602 (may also be referred to as a control unit), a memory 604, and a system bus 606. The computer system 600 may include at least one computing device having the processor device 602. The system bus 606 provides an interface for system components including, but not limited to, the memory 604 and the processor device 602. The processor device 602 may include any number of hardware components for conducting data or signal processing or for executing computer code stored in memory 604. The processor device 602 (e.g., control unit) may, for example, include a general-purpose processor, an application specific processor, a Digital Signal Processor (DSP), an Application Specific Integrated Circuit (ASIC), a Field Programmable Gate Array (FPGA), a circuit containing processing components, a group of distributed processing components, a group of distributed computers configured for processing, or other programmable logic device, discrete gate or transistor logic, discrete hardware components, or any combination thereof designed to perform the functions described herein. The processor device may further include computer executable code that controls operation of the programmable device.

The system bus 606 may be any of several types of bus structures that may further interconnect to a memory bus (with or without a memory controller), a peripheral bus, and/or a local bus using any of a variety of bus architectures. The memory 604 may be one or more devices for storing data and/or computer code for completing or facilitating methods described herein. The memory 604 may include database components, object code components, script components, or other types of information structure for supporting the various activities herein. Any distributed or local memory device may be utilized with the systems and methods of this description. The memory 604 may be communicably connected to the processor device 602 (e.g., via a circuit or any other wired, wireless, or network connection) and may include computer code for executing one or more processes described herein. The memory 604 may include non-volatile memory 608 (e.g., read-only memory (ROM), erasable programmable read-only memory (EPROM), electrically erasable programmable read-only memory (EEPROM), etc.), and volatile memory 610 (e.g., random-access memory (RAM)), or any other medium which can be used to carry or store desired program code in the form of machine-executable instructions or data structures and which can be accessed by a computer or other machine with a processor device 602. A basic input/output system (BIOS) 612 may be stored in the non-volatile memory 608 and can include the basic routines that help to transfer information between elements within the computer system 600.

The computer system 600 may further include or be coupled to a non-transitory computer-readable storage medium such as the storage device 614, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 614 and other drives associated with computer-readable media and computer-usable media may provide non-volatile storage of data, data structures, computer-executable instructions, and the like.

A number of modules can be implemented as software and/or hard coded in circuitry to implement the functionality described herein in whole or in part. The modules may be stored in the storage device 614 and/or in the volatile memory 610, which may include an operating system 616 and/or one or more program modules 618. All or a portion of the examples disclosed herein may be implemented as a computer program product 620 stored on a transitory or non-transitory computer-usable or computer-readable storage medium (e.g., single medium or multiple media), such as the storage device 614, which includes complex programming instructions (e.g., complex computer-readable program code) to cause the processor device 602 to carry out the steps described herein. Thus, the computer-readable program code can comprise software instructions for implementing the functionality of the examples described herein when executed by the processor device 602. The processor device 602 may serve as a controller or control system for the computer system 600 that is to implement the functionality described herein.

The computer system 600 also may include an input device interface 622 (e.g., input device interface and/or output device interface). The input device interface 622 may be configured to receive input and selections to be communicated to the computer system 600 when executing instructions, such as from a keyboard, mouse, touch-sensitive surface, etc. Such input devices may be connected to the processor device 602 through the input device interface 622 coupled to the system bus 606 but can be connected through other interfaces such as a parallel port, an Institute of Electrical and Electronic Engineers (IEEE) 1394 serial port, a Universal Serial Bus (USB) port, an IR interface, and the like. The computer system 600 may include an output device interface 624 configured to forward output, such as to a display, a video display unit (e.g., a liquid crystal display (LCD) or a cathode ray tube (CRT)). The computer system 600 may also include a communications interface 626 suitable for communicating with a network as appropriate or desired.

FIG. 8 illustrates a computer readable medium 810 carrying a computer program comprising program code means 820 for performing the methods illustrated in FIG. 7 and the techniques discussed herein, when said program product is run on a computer. The computer readable medium and the code means may together form a computer program product 800.

The operational steps described in any of the exemplary aspects herein are described to provide examples and discussion. The steps may be performed by hardware components, may be embodied in machine-executable instructions to cause a processor to perform the steps, or may be performed by a combination of hardware and software. Although a specific order of method steps may be shown or described, the order of the steps may differ. In addition, two or more steps may be performed concurrently or with partial concurrence.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the inventive concepts being set forth in the following claims.

1. A computer-implemented method, for monitoring tyre radius data associated with one or more wheels of a heavy-duty vehicle, the method comprising selecting, by a processor device of a computer system, at least a subset of the one or more wheels of the heavy-duty vehicle,
obtaining, by the processor device, respective wheel speeds for the wheels in the selected subset of wheels,
determining, by the processor device, relative tyre radii quotients based on the tyre radius data and corresponding wheel speed quotients based on the wheel speeds, respectively, and declaring, by the processor device, an error if a difference between the relative tyre radii quotients and the corresponding wheel speed quotients fails to satisfy a difference acceptance criterion.

2. The method according to claim 1, comprising selecting, by the processor device, a plurality of different subsets of wheels of the heavy-duty vehicle and identifying one or more failing wheels based which subsets out of the plurality of selected subsets that generate a declared error by the processor device.

3. The method according to claim 1, where the tyre radius data comprises tyre radii which have been estimated based on a travelled distance by the vehicle and on a corresponding number of wheel rotations.

4. The method according to claim 1, where the tyre radius data comprises tyre radii which have been estimated based on output signals from one or more inertial measurement units, IMU.

5. The method according to claim 1, where the tyre radius data comprises tyre radii which have been estimated based on a measured vehicle speed and on a corresponding wheel speed of rotation.

6. The method according to claim 1, where the tyre radius data comprises tyre radii which have been pre-configured by the processor device.

7. The method according to claim 1, comprising obtaining the wheel speeds from Hall effect sensors or rotary encoders arranged in connection to the wheels.

8. The method according to claim 1, determining the relative tyre radii quotients as
$$\frac{{R}_{i}}{{R}_{j}}$$
where Rᵢ and Rⱼ are tyre radii of the i-th and j-th wheel of the heavy-duty vehicle, and determining the corresponding wheel speed quotients as
$$\frac{{ω}_{xi}}{{ω}_{xj}}$$
where ωₓᵢ and ωₓⱼ are the wheel speeds of the i-th and j-th wheel.

9. The method according to claim 1, comprising declaring an error if
$$abs ( \frac{{ω}_{xi}}{{ω}_{xj}} - \frac{{R}_{i}}{{R}_{j}} ) \geq Th$$
where Th is a predetermined threshold value, Rᵢ and Rⱼ are measured or estimated tyre radii of the i-th and j-th wheel of the heavy-duty vehicle, and where ωₓᵢ and ωₓⱼ are wheel speeds of the i-th and j-th wheel of the heavy-duty vehicle.

10. The method according to claim 1, comprising triggering generation of a notification and/or warning message to a vehicle motion management, VMM, system of the heavy-duty vehicle in response to declaring an error by the processor device.

11. The method according to claim 1, comprising reducing a vehicle speed, and/or executing a situation avoidance maneuver, SAM, in response to declaring an error by the processor device.

12. The method according to claim 1, comprising obtaining data indicative of a current motion state of the heavy-duty vehicle, and declaring an error only if the current motion state satisfies a motion state acceptance criterion.

13. The method according to claim 12, where the motion state acceptance criterion comprises any of; a vehicle curvature criterion, a vehicle acceleration criterion, and a vehicle wheel force criterion.

14. A vehicle comprising a processor device configured to perform the method of claim 1.

15. A computer program product comprising program code for performing, when executed by the processor device, the method of claim 1.

16. A non-transitory computer-readable storage medium comprising instructions, which when executed by a processor device, cause the processor device to perform the method of claim 1.

17. A computer system comprising a processor device configured to monitor tyre radius data associated with one or more wheels of a heavy-duty vehicle, where the processor device is configured to
select at least a subset of the one or more wheels of the heavy-duty vehicle,
obtain respective wheel speeds for the wheels in the selected subset of wheels,
determine relative tyre radii quotients based on the tyre radius data and corresponding wheel speed quotients based on the wheel speeds, respectively, and
declare an error if a difference between the relative tyre radii quotients and the corresponding wheel speed quotients fails to satisfy a difference acceptance criterion.
